(19) United States
(12) Patent Application Publication
(10) Pub. No.: US 2013/0135116 A1
(43) Pub. Date: May 30, 2013

(54) METHOD FOR PROCESSING DATA IN A DOMESTIC APPLIANCE, DOMESTIC APPLIANCE AND SYSTEM HAVING A DOMESTIC APPLIANCE AND AT LEAST ONE EXTERNAL UNIT

(71) Applicants: Thomas Garbe, Ottobrunn (DE); Claudia Häpp, Munchen (DE); Cornelia Niebler, Munchen (DE)

(72) Inventors: Thomas Garbe, Ottobrunn (DE); Claudia Häpp, Munchen (DE); Cornelia Niebler, Munchen (DE)

(73) Assignee: BSH BOSCH UND SIEMENS HAUSGERÄTE GMBH, Munich (DE)

(21) Appl. No.: 13/816,248

(22) PCT Filed: Aug. 18, 2011
(86) PCT No.: PCT/EP11/64199

§ 371 Date: Feb. 11, 2013

(30) Foreign Application Priority Data
Aug. 31, 2010 (DE) 10 2010 040 032.7

(51) Int. Cl. G08C 19/00

(52) U.S. Cl. CPC G08C 19/00
USPC 340/870.02

(57) ABSTRACT

In a method for processing data from a domestic appliance, appliance data from the domestic appliance is determined and at least part of the determined appliance data is incorporated in a user profile. At least part of the user profile is useable for information purposes through display on a display unit or transmission to an external unit.

The invention relates to a method for processing data from a domestic appliance. The invention further relates to a domestic appliance for use during the course of the method. The invention also relates to a system having a domestic appliance and at least one external unit, set up to perform the method together.

Intelligent power meters are known, which allow a private household to measure and display the precise power consumption of the whole household, power consumption curves for the whole household over certain time periods and time or load-dependent tariffs. These can be displayed directly at the intelligent power meter, by way of a separate display unit in the living area or by way of other media, for example PC, TV or mobile telephone.

The object of the present invention is to provide a particularly versatile and user-friendly domestic appliance usage.

This object is achieved according to the features of the independent claims. Preferred embodiments will emerge in particular from the dependent claims.

The object is achieved by a method for processing data from a domestic appliance, the method having at least the following steps:

determining appliance data from the domestic appliance,

incorporating at least some of the determined appliance data in a user profile and

providing at least some of the user profile for information purposes.

The user profile and its provision for information purposes have the advantage that a user can be shown his/her typical behavior or behavior pattern in respect of the domestic appliance, for example with regard to energy consumption.

In one preferred development provision comprises the transmission of at least some of the user profile to an external body. Thus for example any deviation from the behavior pattern stored in the user profile can be identified by the external body, for example in the context of an age-appropriate ambient assisted living system (AAL). The user profile can also be supplied to a (for example factory) customer service department for more effective repair and/or maintenance. The user profile can also be supplied, sufficiently anonymized if necessary, to a housing manager, a residential complex supervisor, an energy supply company, etc., as external bodies, for example to provide the user with suggestions for improving his/her usage of the domestic appliance, e.g. in respect of optimizing energy consumption or using economical power tariffs. It is also possible to use the user profile to draw more accurate conclusions about the nature of the domestic appliance (e.g. “fairly old washing machine” or “microwave oven”), without knowing details of the domestic appliance beforehand. From this knowledge the external body (e.g. a customer service department or sales unit) can supply a user for example with information about energy-saving appliance innovations, maintenance articles and/or care products.

A user profile can refer in particular to a set containing at least one data record, wherein at least one data record comprises a logical linking of appliance data, in particular consumption data, determined over a number of actuation intervals of the domestic appliance. The user profile can additionally comprise one or more of the previously determined appliance data items or other data items for the current (last performed) actuation interval, e.g. time data (time, day, date, etc.).

An actuation interval can refer in particular to an activation period of the domestic appliance (interval between switching on or activating and switching off or deactivating) and/or a sequence of an operating program of the domestic appliance.

Determining appliance data refers in particular to the measuring of appliance data, e.g. by means of a corresponding sensor or measuring facility and/or deriving or estimating appliance data, e.g. by linking a known energy consumption for a load to an activation period for said load. Energy consumption can be determined and/or displayed generally for the domestic appliance as a whole or for individual consumers or loads of the domestic appliance.

Incorporating the determined appliance data in a user profile can refer in particular to a logical linking or adding of currently determined appliance data to at least one data record of the user profile, whereby the at least one data record can comprise in particular (apart from initial incorporation) previously determined appliance data of the same type. Incorporation can include a linking of appliance data of the same or different type.

Providing at least some of the user profile (in particular the whole user profile) for information purposes can refer in particular to this part of the user profile being supplied just for information purposes. This embodiment implies in particular that such data is not used by the domestic appliance for its control, in other words for example is not supplied to a control unit for control purposes.

The object is also achieved by a domestic appliance, the domestic appliance being set up to perform the steps of the method relating to the domestic appliance. To perform the step of incorporating at least a subset of the determined appliance data in a user profile, the domestic appliance can have a correspondingly set up data processing unit, which is coupled for communication purposes in particular to the at least one appliance data determination facility, in order to receive the appliance data determined thereby. In this instance the domestic appliance itself can therefore be set up to incorporate the determined appliance data in the user profile. Alternatively or additionally the domestic appliance can have at least one data communication interface and be set up to output determined appliance data by way of the data communication interface (in particular to an external data processing unit, which is set up to incorporate the determined appliance data in a user profile). The domestic appliance can also add one or more of the previously determined appliance data items or other data items for the current (last performed) actuation interval to the user profile.

The at least one data communication interface can comprise a wireless data communication interface (e.g. Bluetooth interface, WLAN interface, mobile radio interface, IR interface, etc.) and/or a wired data communication interface (e.g. an Ethernet interface or a PLC interface).

In one preferred embodiment the domestic appliance has at least one appliance data determination facility for determining appliance data. Alternatively or additionally the appliance data can be estimated or calculated.

In a further preferred embodiment the determination of appliance data at least comprises:

determining at least one energy information item from the domestic appliance (e.g. power consumption, electrical output or another energy information item);

determining at least one temporal information item relating to the operation of the domestic appliance (e.g. a time and/or duration of an actuation interval);

determining at least one program selection information item (e.g. type of operating programs set and/or program parameters); and/or

determining at least one program sequence information item (e.g. in the case of a tumble dryer a laundry weight, drying sequence duration, drum speed, energy consumption (see above), etc. for a predefined drying program).

This appliance data has the advantage that it can assist appliance usage optimization, in particular a reduction of energy consumption, particularly effectively.

In a further preferred embodiment the incorporation of the determined appliance data in a user profile at least comprises:

adding up over a number of actuation intervals of the domestic appliance (e.g. adding up an energy consumption to obtain the overall energy consumption of the domestic appliance);

averaging over a number of actuation intervals of the domestic appliance (e.g. averaging an energy consumption to obtain an average energy consumption of the domestic appliance for each actuation interval);

adding to a temporal distribution over a number of actuation intervals of the domestic appliance (e.g. classifying in predefined tariff intervals of an energy supply company); and/or

adding to a frequency distribution over a number of actuation intervals of the domestic appliance (e.g. adding to a frequency distribution for the utilization of different operating programs).

Such incorporating or processing of the appliance data has the advantage that an optimization and/or forecast of appliance usage, in particular a reduction of energy consumption, can be assisted particularly effectively.

In a further preferred embodiment the incorporation of the determined appliance data and where applicable the adding of the appliance data and other data of the current actuation interval in a user profile takes place outside the domestic appliance. The domestic appliance is then not subject to a hardware and/or software outlay in order to incorporate the determined appliance data. To this end the domestic appliance can have in particular the above-mentioned at least one data communication interface, to transmit the appliance data directly or indirectly to an external data processing unit for the incorporation of the determined appliance data in a user profile.

The external data processing unit can be a dedicated external data processing unit, which is provided and set up solely for the purpose of incorporating the determined appliance data (or some of it) etc. in a user profile and optionally outputting, in particular displaying, at least one data record of the user profile.

Alternatively the external data processing unit can be a general data processing unit, which is set up additionally for the purpose of incorporating the determined appliance data in a user profile and optionally for outputting, in particular displaying, at least one data record of the user profile. The external data processing unit can be for example a personal computer (desktop, laptop, netbook, etc.), smartphone, PDA, iPad, iPod, etc. The external data processing unit can also be a central server, e.g. of a residential complex or an energy supply company. The external data processing unit can be set up for example by means of a specific application program or “app” for the cited purpose. The external data processing unit can communication with the domestic appliance directly by way of the data communication interface of the domestic appliance or indirectly, for example by way of a gateway or another switching facility. The external data processing unit can optionally be provided and set up to output, in particular to display, at least one data record of the user profile. To this end the external data processing unit can have a display unit for displaying at least one data record of the user profile or can be integrated with this in a common device.

In another preferred embodiment the determined appliance data is incorporated in a user profile by the domestic appliance, in particular by means of the internal data processing unit. This allows the method to be performed autonomously and communication outlay can be reduced.

In one preferred development the method comprises a step of outputting, in particular displaying, or even in some instances printing, etc., at least one data record of the user profile.

In another preferred development the outputting of the at least one data record of the user profile comprises outputting to at least one display unit external to the domestic appliance. The display unit external to the domestic appliance can be for example a display unit of the external data processing unit, e.g. of a personal computer (desktop, laptop, netbook, etc.), smartphone, PDA, iPad, iPod, etc. Alternatively the display unit external to the domestic appliance can be a dedicated display unit, which is essentially provided and set up solely for the purpose of displaying. This development has the advantage that a user can retrieve the data easily even remotely from the domestic appliance.

In one alternative or additional preferred development the outputting of the at least one data record of the user profile comprises outputting to at least one display unit of the domestic appliance, in particular to at least one display unit of a user interface of the domestic appliance. This provides a compact, low-cost and permanently available display option.

In a further preferred embodiment the method also has the following step: using at least one data record of the user profile to generate at least one usage forecast (possibly including usage optimization) for the domestic appliance. The usage forecast can be used for example to anticipate energy provision for the domestic appliance. To this end the data record can comprise in particular energy information (power consumption, output, etc.), in particular linked to temporal information, e.g. a time period of appliance usage.

In one preferred development the method comprises the use of at least one data record of a user profile for a number of domestic appliances respectively to generate at least one usage forecast (possibly including usage optimization). The domestic appliances can include for example a number of domestic appliances (e.g. washing machine, dryer, refrigerator, cooking appliance, coffee maker, microwave, etc.) of a household, so that a usage forecast, in particular an energy consumption forecast, can be produced for a household. Such a household-related usage forecast can be used for example to anticipate energy provision for the household.

The at least one usage forecast can be generated by means of a correspondingly set up external data processing facility, which is connected for communication purposes to the domestic appliances. To this end the domestic appliances each have a data communication interface. The external data processing facility can be the data processing facility assigned to the household, in particular present in the household. The external data processing facility can alternatively be a data processing facility of a unit of a higher order than the household, e.g. a residential unit comprising a number of households. The external data processing facility can communicate with the domestic appliances, for example by way of a communication network of the household or of the residential unit.

Similarly the method can comprise the use of at least one data record of a user profile for a number of households in a residential unit respectively and/or the use of at least one data record of a user profile for a number of households in a section of street respectively or similar, to generate at least one usage forecast.

Generally the domestic appliance can be set up for remote retrieval and can have a data communication interface or use the data communication interface for this purpose. The domestic appliance itself can be set up to incorporate the determined appliance data in a user profile, to output at least one data record of the user profile to at least one display unit of the domestic appliance and/or to use the at least one data record of the user profile to generate at least one usage forecast for the domestic appliance.

The usage forecast can also be used in particular in the context of an age-appropriate ambient assisted living system (AAL). If for example a defined behavior pattern can be identified from a user profile or usage forecast (e.g. a typical sequence of a laundry wash cycle, followed by a laundry drying cycle within a predefined time), a deviation therefrom (e.g. the absence of a laundry drying cycle within the predefined time of usage) can indicate a possible instance of assistance for the user and appropriate actions can be initiated, e.g. a telephone call to check.

The domestic appliance can in principle comprise any electrically operated domestic appliance, e.g. a laundry treatment appliance (washing machine, dryer, washer/dryer, etc.), a refrigeration appliance (refrigerator, chest freezer, etc.), a cooking appliance (cooker, oven, cooktop, steam cooker, etc.), a small domestic appliance (coffee maker, microwave, mixer, toaster, trouser press, etc.), etc.

The object is also achieved by a system comprising a domestic appliance and at least one external unit, the domestic appliance and the at least one external unit being set up to interact to perform the method as described above. The external unit can be embodied in particular as an external data processing unit and/or an external display unit.

Generally the method can be performed on the domestic appliance or on a domestic appliance and at least one external device.

The invention can also comprise the following aspects in particular:

A domestic appliance can determine (e.g. measure and/or estimate or calculate) some or all of its appliance data, then combine at least some of the appliance data computationally and/or visualize the at least some appliance data and/or combinations thereof. The appliance data can comprise for example energy consumption, a power consumption value for the domestic appliance or individual components, time, duration and frequency of usage of the domestic appliance, a program selection and associated program parameters as well as trend data in the appliance process. The appliance data can be determined and/or processed by means of corresponding hardware and software modifications of the domestic appliance. The domestic appliance can then generate user profiles or data profiles therefrom, which can be used for further purposes.

The data analysis can take place directly at the domestic appliance and the resulting user profiles can then be visualized for example directly at the domestic appliance; visualized on a separate, dedicated display unit, e.g. in a living area, in so far as a data exchange is ensured between the domestic appliance and the display unit; and/or on any other display medium, such as a PC, mobile telephone, TV, etc., in so far as a data exchange is also ensured here between the domestic appliance and the display medium. In some instances this assumes a corresponding data communication interface at the domestic appliance and at the display device. The appliance data and the data generated computationally by the domestic appliance (user profile, etc.) can preferably also be read by third parties, for example service points, residential complex supervisors and power suppliers, if the data communication interface is present, suitably anonymized if necessary.

Two instances of implementation in particular are conceivable, which can be applied separately or combined.

The first instance relates to the determination, analysis and displaying of the appliance data and user profiles solely at the domestic appliance. The determined (in particular measured) appliance data or input variables for a display, for example energy consumption, a power consumption value for the domestic appliance or individual components, time, duration and frequency of usage of the domestic appliance, a program selection and associated program parameters as well as trend data in the appliance process, are displayed on a display unit directly at the domestic appliance, in particular in meaningful combinations. This display can be quantitative, in the form of a purely numerical display, or qualitative, in the form of trend curves, diagrams and other images.

To implement the first instance at least one display unit or at least one visualization module in particular can be present on the domestic appliance, for example a known display unit, e.g. of a tumble dryer, for displaying a start time preselection, time remaining, residual moisture, temperature and process status. The display unit can be in particular a pixel-controlled display unit, e.g. a liquid crystal display.

The appliance data, in particular appliance consumption data, can be supplied by way of a separate electronic module or it can be done by integration into an electronic unit, in particular a control facility, of the domestic appliance. Hardware and software adjustments can thus take place on and/or in the domestic appliance, for example by providing further operating elements and software for determining the appliance data.

In a second instance analysis and displaying or just displaying of the determined appliance data, in particular appliance consumption data, and user profiles can be performed on external devices, in particular in conjunction with remote readability. The appliance data or input data can be transmitted for example to display units external to the domestic appliance, for example a PC, mobile telephone or TV, and displayed there. In the second instance the domestic appliance and the at least one external device can each have a data communication interface for transmitting data at least from the domestic appliance to the at least one external device (optionally also for bidirectional data communication). An algorithm for processing the incoming signals for example can run on the external device, for example for the remote retrieval of the appliance data, e.g. by a customer service department or other service points.

The at least one external device can be coupled for communication purposes directly to the domestic appliance or indirectly, for example by way of a switching unit, e.g. a gateway. The switching unit may be an intelligent power meter or smart meter for example. The switching unit may be set up to pass on domestic appliance-specific data (appliance data, user profiles, etc.) to third parties, for example energy suppliers, residential complex supervisors, service points and customer service departments.

A third instance can be a combination of the first and second instances, it being possible for displaying and forecasting in particular to be performed as in the second instance. The third instance comprises in particular the linking of different user profiles, in particular in respect of energy consumption and further data as well as in respect of the deriving or/or forecasting of user behavior. It is thus currently known that current/voltage profiles in the household can uniquely show usage of a microwave appliance. Said data can be meaningfully linked, in order to improve forecasts for smaller units (streets, city areas, whole cities or regions, etc.). Such data represents a potential value added for energy suppliers, as energy generation can be optimally matched to a better forecast of user behavior.

Such data could also be used as follows in respect of analysis: If a user uses a “fairly old” washing machine (this recognition can be derived from high power and water consumption), targeted customer advice can be offered by way of information leaflets, email messages and/or by means of specific energy-optimized advice. It is thus possible to address possible customer groups in a more targeted manner.

The advantages that can be achieved with the present invention can for example include:

by displaying user profiles and forecast data it is possible to counteract excessive appliance wear. Also the topic of “energy saving” can be brought to the notice of the user.

by allowing the domestic appliance to be read remotely, any susceptibility to failure of the domestic appliance can be identified promptly by service points and customer service departments and can in some instances be visualized in situ for the end user at the appliance.

by reading appliance curves and activities and by identifying and deriving behavior patterns, it is possible to identify remotely how the end user is (ambient assisted living aspect). The displaying of such a scenario is also conceivable directly at the domestic appliance, in that in the case of certain abnormal interactions with the domestic appliance (for example if a tumble dryer is not emptied after a period of more than 24 hours), a warning signal is generated at the domestic appliance or this behavior is forwarded to a central point (control center or the like).

by reading user profiles, it is possible to send correspondingly targeted information to the associated household, e.g. advertisements for appliance innovations, maintenance articles and care products.

a factory customer service department can use such data for repair and service purposes.

energy consumption can be optimized by suggested improvements generated on the basis of the data profiles by third parties, in particular energy suppliers and residential complex supervisors and forwarded to the household.

The invention is illustrated schematically based on exemplary embodiments in the figures described below in the accompanying drawing. For the sake of clarity identical elements or those of identical effect are shown with identical reference characters. In the drawing:

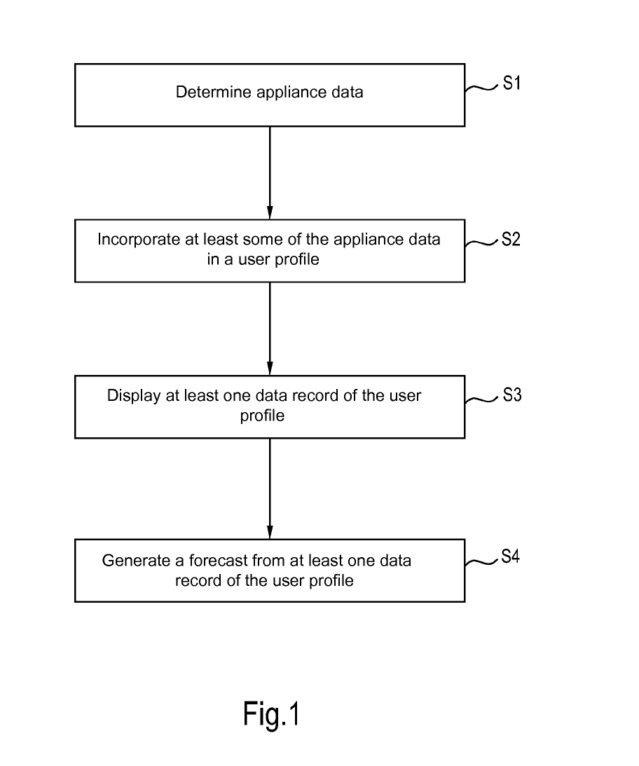

FIG. 1 shows a possible sequence of the inventive method;

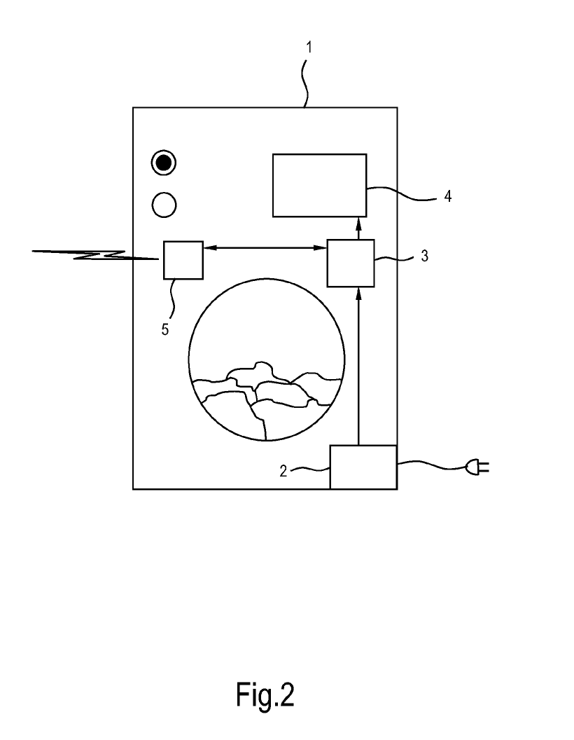

FIG. 2 shows an inventive domestic appliance in the form of a washing machine;

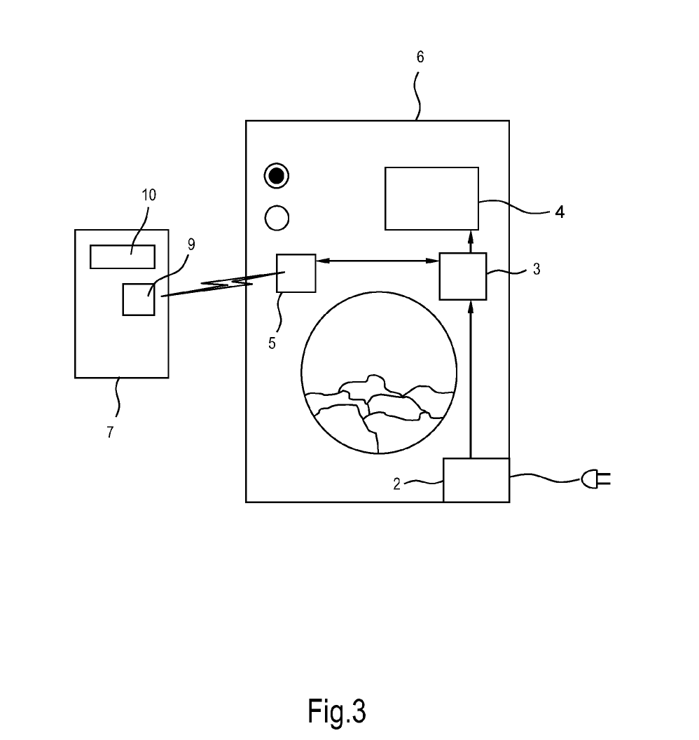

FIG. 3 shows an inventive system comprising a domestic appliance in the form of a washing machine and a device external to the domestic appliance.

FIG. 1 shows a possible sequence of the method. In a first step S1 appliance data of a domestic appliance, e.g. a washing machine 1 or 6 (see FIG. 2 and FIG. 3) is determined, in other words measured and/or derived. In particular a program selection (e.g. an operating program in the form of a boil wash cycle), an associated energy consumption (power or output) for the last operating program run and temporal information (start, end, duration) of the last operating program run are determined. The duration of the operating program represents an actuation interval.

In a second step S2 at least some of the determined appliance data is incorporated in a user profile, which links together at least some of this appliance data for a number of actuation intervals. For example the user profile can comprise the following data records:

the selected programs (e.g. 60% delicate wash cycle with spin, 20% boil wash cycle with spin, 5% wool wash cycle without spin, 15% just spin cycle) since the washing machine came into operation or since the last service;

energy consumption (e.g. power consumption or output) of the last actuation interval;

average energy consumption since the washing machine came into operation or since the last service, optionally assigned to respective programs,

overall energy consumption since the washing machine came into operation or since the last service and/or

cumulative energy consumption over a time and optionally a date since the washing machine came into operation or since the last service.

Other time periods can be used for the user profile instead of the time since the washing machine came into operation or since the last service, e.g. a defined number of actuations or a defined time interval (e.g. n weeks or months).

In a third step S3 at least one data record of the user profile is output or displayed by means of at least one display unit, e.g. the energy consumption of the last or current actuation interval and/or the overall energy consumption. Such a display can generally take place automatically (e.g. during a switch-off sequence) and/or at the explicit request of or when approved by the user.

In a fourth step S4 at least one of the data records of the user profile can be used to generate at least one forecast (including future usage optimization) for the domestic appliance. For example the energy consumption of the last (current) actuation interval can be compared with a threshold value or with the average energy consumption for the same program. If the threshold is reached and/or there is a significant deviation from the average energy consumption, this may indicate a need for maintenance or repair. The cumulative energy consumption over the time and optionally the date (e.g. typically two wash cycles on a Wednesday afternoon) can be used to forecast future actuation and therefore optimized power provision (e.g. by an energy supplier). Usage optimization may also be suggested to a user, for example using the washing machine when the power tariff is more favorable, e.g. on a Saturday afternoon. It can also be forecast when the next appliance service is due.

In one development the usage optimization option has to be explicitly permitted or requested by a user. In one development the forwarding of data to third parties (e.g. a service point) only takes place with the explicit permission of the user, optionally on a case by case basis.

Steps S3 and S4 can also be performed in the reverse sequence or at the same time. Steps S3 and S4 can also be performed alone in combination with steps S1 and S2.

FIG. 2 shows a possible washing machine 1, which is set up to perform the steps S1 to S4. To this end the washing machine 1 has an appliance data determination unit in the form of a power measuring facility 2, which can be used to measure the power currently consumed by the washing machine 1. The washing machine 1 also has a central control unit 3, which is coupled to the power measuring facility 2 and determines the power consumption or the consumed output over the current actuation interval (in this instance the duration of the activated operating program). Alternatively the power measuring facility 2 can be omitted and the energy consumption can be estimated by means of the control unit 3, e.g. by detecting an activation period of one or more consumers with known energy consumption (output, etc.).

The central control unit 3 also incorporates and stores the appliance data determined by the power measuring facility (power level, output, etc.) in a user profile.

The central control unit 3 is coupled to a pixel-controlled display unit 4, which is part of a user interface of the washing machine 1. Standard texts and parameters for the operation of the washing machine 1, e.g. the program selected, time remaining, etc., can be displayed on the display unit 4, e.g. a liquid crystal display. Variables generated by the method can also be displayed on the display unit 4, e.g. appliance data used for a user profile and/or at least one data record of the user profile.

The central control unit 3 can also generate a forecast for the operation of the washing machine 1, which can be displayed on the display unit 4.

The washing machine 1 can also have at least one data communication interface 5, which is coupled to the control unit 3 for communication purposes. The data communication interface 5 can be used to transmit data generated by means of the method (determined appliance data, at least one data record of the user profile and/or forecast data) to at least one external (to the domestic appliance) device (not shown). Data (e.g. current power tariffs), which can be used to determine the user profile and/or in particular to generate the user forecast (including usage optimization), can also be received from outside by way of the data communication interface 5.

FIG. 3 shows a system comprising a domestic appliance in the form of a washing machine 6 and at least one external (to the domestic appliance) device 7. The external device 7 can be a data processing unit and/or a display unit.

The washing machine 6 also has an appliance data determination unit in the form of a power measuring facility 2, which can be used to measure the power currently consumed by the washing machine 6. The washing machine 6 also has a central control unit 3, which is coupled to the power measuring facility 2 and determines the energy consumption over the current actuation period (in this instance the duration of the activated operating program). Alternatively the power measuring facility 2 can also be omitted here and the energy consumption can be estimated by means of the control unit 3, e.g. by detecting an activation period of one or more consumers with known energy consumption. The central control unit 3 is coupled to a pixel-controlled display unit 4, which is part of a user interface of the washing machine 6. Standard texts and parameters for the operation of the washing machine 6, e.g. the program selected, time remaining, etc., can be displayed on the display unit 4, e.g. a liquid crystal display.

The washing machine 6 has at least one data communication interface 5, which is coupled to the control unit 3 for communication purposes. The data communication interface 5 can be used to transmit data required to generate the user profile of the washing machine 6 (determined appliance data, time data, etc.) to the external device 7. To this end the external device 7 has a data communication interface 9, which can exchange data with the data communication interface 5 of the washing machine.

The external device 7 is set up to produce a user profile based on the data transmitted by the washing machine 6 or to incorporate or enter the data in a user profile. The external device 7 is therefore configured at least as an external data processing unit. While step S1 is therefore performed by the washing machine 6, step S2 is performed by the external device 7. Data (e.g. current power tariffs), which can be used to determine the user profile and/or in particular to generate the user forecast (including usage optimization), can also be received from outside (in other words not from the washing machine 6) by way of the data communication interface 9.

The variables generated by the method can also now be displayed on a display unit 10 of the external device 7 (step S3), e.g. transmitted appliance data and/or at least one data record of the user profile. The external device 7 is therefore also configured as an external display unit. The data communication interfaces 5 and 9 can also be used to transmit the variables that can be displayed in the external device 7 to the washing machine 6 and to display them there on the display unit 4.

The external device 7 can also be used to generate at least one forecast for the operation of the washing machine 6 (step S4), which can be displayed on the display unit 10. The data communication interfaces 5 and 9 can also be used to transmit the at least one forecast or corresponding forecast data to the washing machine 6 and display it there on the display unit 4.

The present invention is of course not limited to the exemplary embodiments shown.

The exemplary embodiments can therefore also be executed by any other electrically operated domestic appliance instead of the washing machine.

### LIST OF REFERENCE CHARACTERS

1 Washing machine
2 Power measuring facility
3 Control unit
4 Display unit
5 Data communication interface
6 Washing machine
7 External device
9 Data communication interface
10 Display unit
S1 First step
S2 Second step
S3 Third step
S4 Fourth step

1-15. (canceled)

16. A method for processing data from a domestic appliance, said method comprising the steps of:
determining appliance data from the domestic appliance;
incorporating at least part of the determined appliance data in a user profile; and
providing at least part of the user profile for information purposes.

17. The method of claim 16, wherein the providing step includes the step of transmitting the part of the user profile to an external body.

18. The method of claim 17, wherein the external body is at least one of an age-appropriate ambient assisted living system and a customer service department.

19. The method of claim 16, wherein the determining step includes at least one step selected from the group consisting of determining at least one energy information item from the domestic appliance, determining at least one temporal information item relating to an operation of the domestic appliance, determining at least one program selection information item, and determining at least one program sequence information item.

20. The method of claim 16, wherein the incorporating step includes at least one step selected from the group consisting of adding up over a number of actuation intervals of the domestic appliance, averaging over a number of actuation intervals of the domestic appliance, adding to a temporal distribution over a number of actuation intervals of the domestic appliance, and adding to a frequency distribution over a number of actuation intervals of the domestic appliance.

21. The method of claim 16, wherein the incorporating step takes place outside the domestic appliance.

22. The method of claim 16, wherein the incorporating step is performed by the domestic appliance.

23. The method of claim 16, further comprising the step of outputting at least one data record of the user profile to at least one display unit external to the domestic appliance.

24. The method of claim 16, further comprising the step of outputting at least one data record of the user profile to at least one display unit of the domestic appliance.

25. The method of claim 16, further comprising the step of using at least one data record of the user profile to generate at least one usage forecast for the domestic appliance.

26. A domestic appliance constructed to determine appliance data, to incorporate at least part of the determined appliance data in a user profile, and to provide at least part of the user profile for information purposes.

27. The domestic appliance of claim 26, comprising at least one appliance data determination facility for determining the appliance data.

28. The domestic appliance of claim 26, comprising at least one communication interface for transmission of data to an external device.

29. The domestic appliance of claim 26, wherein the at least one communication interface is a wireless communication interface.

30. The domestic appliance of claim 26, constructed for remote reading.

31. A system, comprising:
a domestic appliance constructed to determine appliance data and to incorporate at least part of the determined appliance data in a user profile; and
at least one external unit interacting with the domestic appliance to provide at least part of the user profile for information purposes.

32. A domestic appliance, comprising:
a measuring device for determining appliance data;
a control unit operably connected to the measuring device and constructed to incorporate at least part of the determined appliance data in a user profile; and
a display unit operably connected to the control unit to display at least part of the user profile for information purposes.

33. The domestic appliance of claim 32, further comprising a data communication interface for transmitting the part of the user profile to an external body.
